(19) United States
(12) Patent Application Publication
(10) Pub. No.: US 2023/0332274 A1
(43) Pub. Date: Oct. 19, 2023

(54) RECOVERING RARE EARTH ELEMENTS AND OTHER TRACE METALS FROM CARBON-BASED ORES

(71) Applicant: Red Leaf Resources, Inc., Salt Lake City, UT (US)

(72) Inventor: James Patten, Salt Lake City, UT (US)

(21) Appl. No.: 18/184,580

(22) Filed: Mar. 15, 2023

Related U.S. Application Data
(60) Provisional application No. 63/320,360, filed on Mar. 16, 2022.

(51) Int. Cl. C22B 3/42; C22B 3/04; C22B 5/04; C22B 5/12; C22B 9/16; C22B 3/22; C22B 59/00

(52) U.S. Cl. CPC C22B 59/00; C22B 3/04; C22B 3/22; C22B 3/42; C22B 5/04; C22B 5/12; C22B 9/16

(57) ABSTRACT

A method of recovering rare earth elements and other trace metals from based ores can include providing a body of rubblized carbon-based ore. The rubblized carbon-based ore can include carbonates and rare earth elements. The carbonates in the ore can be decomposed at an elevated decomposition temperature and an oxygen deficient atmosphere to form an enriched spent ore and carbon dioxide.

### RELATED APPLICATION

This application claims priority to U.S. Provisional Application No. 63/320,360, filed Mar. 16, 2022.

### BACKGROUND

Rare earth elements are a series of heavy metals having similar properties, including scandium, yttrium, lanthanum, cerium, praseodymium, neodymium, promethium, samarium, europium, gadolinium, terbium, dysprosium, holmium, erbium, thulium, ytterbium, and lutetium. The rare earth elements have many applications in electronics, lasers, glass, magnets, catalysts, and others. Because of their chemical properties, the rare earth elements are usually highly dispersed in low concentrations in other minerals instead of in concentrated rare earth element deposits. Therefore, recovery of rare earth elements typically involves separating the rare earth elements from significant amounts of other materials.

### SUMMARY

The present disclosure describes methods of recovering rare earth elements and other trace metals from carbon-based ores. In some examples, a method of recovering rare earth elements and other trace metals from carbon-based ore can include providing a body of rubblized carbon-based ore that includes carbonates and rare earth elements. The carbonates can be decomposed at an elevated decomposition temperature in an oxygen deficient atmosphere. This can form an enriched spent ore and carbon dioxide.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a flow diagram showing a method of recovering rare earth elements and other trace metals from carbon-based ores in accordance with one example.

FIG. 2 is a schematic illustration of a system for recovering rare earth elements and other trace metals from carbon-based ores in accordance with one example.

FIG. 3 is a schematic illustration of another system for recovering rare earth elements and other trace metals from carbon-based ores in accordance with another example.

FIG. 4 is a schematic illustration of another system for recovering rare earth elements and other trace metals from carbon-based ores in accordance with another example.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a vessel” includes reference to one or more of such systems and reference to “the inlet” refers to one or more of such devices.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

As used herein, whenever any property is referred to that can have a distribution between differing values, such as a temperature distribution, particle size distribution, etc., the property being referred to represents an average of the distribution unless otherwise specified. Therefore, “particle size of the oil shale” refers to an average particle size, and “temperature of the body of oil shale” refers to an average temperature of the body of comminuted oil shale. Average particle sizes can refer to number-average particle sizes. Average temperatures can refer to volumetric-average temperatures.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Methods of Recovering Rare Earth Elements and Other Trace Metals From Carbon-Based Ores

Rare earth elements can be found in varying concentrations in carbon-based ores. As used herein, “carbon-based ore” can include a variety of carbonaceous materials such as oil shale, coal, tar sands, peat, tazmanite, or others. These ores can be found in various locations around the world. The present disclosure describes methods of recovering rare earth elements from these carbon-based ores. In some examples, the methods involve processing the ore by removing other materials, such as hydrocarbon content and carbonate minerals. Removing these materials can have the effect of raising the concentration of rare earth elements in the residual ore. At a higher concentration, the rare earth elements can be separated more easily and cost effectively. The methods described herein can also be used to recover other trace metals such as gallium, germanium, uranium, and others.

In some examples, the rare earth elements or other trace metals can be the main product of the methods described herein. However, in other examples, the methods described herein can be performed as part of a process that produces multiple products such as liquid hydrocarbons, gaseous hydrocarbons, water, energy, commercially pure carbon dioxide, or other products in addition to the rare earth elements and other trace metals. In some cases, the rare earth elements or other trace metals can be a secondary product and the primary product can be one of the other products listed above.

Many carbon-based ores can include carbonate minerals such as calcite, dolomite, siderite, nahcolite, dawsonite, ankerite, barium carbonates (such as ewaldite and burbankite), and others. These minerals can decompose at elevated temperatures, forming carbon dioxide gas. The carbon dioxide gas can be easily removed from the carbon-based ore, such as by pumping the carbon dioxide gas out along with a working fluid that is used to heat the ore. Accordingly, the methods described herein can include heating a body of carbon-based ore to an elevated decomposition temperature to decompose carbonates in the ore.

In some cases, the decomposition temperature can be high enough for combustion to occur. Carbon content in the carbon-based ore may combust, as well as hydrocarbons that may be injected as working fluid. This combustion can generate heat, which increases the temperature of the carbon-based ore. In some examples, the temperature of combustion can be controlled by controlling the amount of oxygen in the atmosphere around the carbon-based ore. The carbon-based ore can be heated in an oxygen deficient atmosphere, meaning that the amount of oxygen present is not sufficient to combust all of the hydrocarbons and other combustible materials present. In certain examples, the atmosphere around the carbon-based ore can have an oxygen concentration of less than 10% by volume. In some cases, the temperature of the carbon-based ore can be controlled to avoid the formation of glasses (e.g. from silicon bearing minerals). However, it can be more difficult to separate rare earth elements from glasses. Therefore, it can be useful to limit the temperature by using an oxygen deficient atmosphere in order to avoid forming glasses in the carbon-based ore.

Hydrocarbon liquids and gases are also valuable products that can be derived from carbon-based ore. In some examples, the methods described herein can include heating the carbon-based or to a temperature at which hydrocarbon liquids and gases are liberated from the ore through pyrolysis. This production of hydrocarbon products can be done before or concurrently with the decomposition of carbonates in the ore. Some carbonate minerals can decompose at the same temperatures used for extracting hydrocarbons, and these carbonates can be decomposed at the same time as the hydrocarbons are extracted. Other carbonates may decompose at a higher temperature. In certain examples, the carbon-based ore can be heated to a first temperature during a hydrocarbon production stage to remove hydrocarbons from the ore, and then the ore can be heated to a higher temperature to decompose carbonates. Any of the heating operations described herein can be performed using an oxygen deficient atmosphere as explained above.

Carbon-based ore that has been heated in order to remove hydrocarbon products can be referred to as “spent” ore. When any material other than the rare earth elements is removed from the carbon-based ore, the concentration of rare earth elements increases in the remaining ore. Thus, spent carbon-based ore can be more suitable for separation of the rare earth elements than fresh carbon-based ore. Removing carbonate minerals can also make the ore more suitable for separation of rare earth elements. Other materials can also be removed from the ore. In some examples, residual coke can be left in the carbon-based ore after other hydrocarbon content has been removed. The residual coke can be burned off to further increase the concentration of rare earth elements in the ore. Some carbon-based ores can also contain trace metals having a low melting point, such as gallium. Gallium melts at about 86° F. (about 30° C.). In some examples a lower temperature heating stage can be used to melt such metals and the metals can be removed from the carbon-based ore. These and other arrangements are described in more detail below.

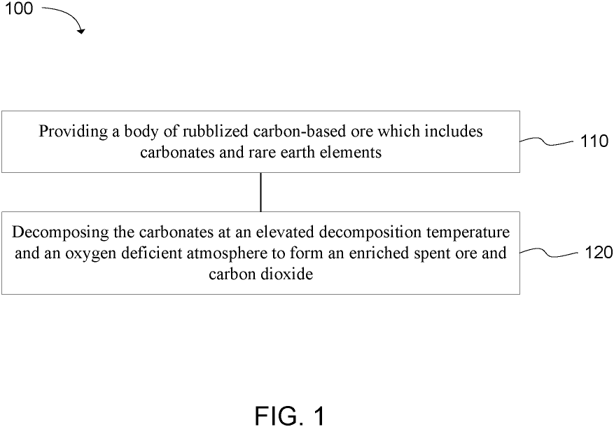

With this description in mind, FIG. 1 is a flowchart illustrating one example method of recovering rare earth elements and other trace metals from carbon-based ores 100. The method includes: providing a body of rubblized carbon-based ore which includes carbonates and rare earth elements 110; and decomposing the carbonates at an elevated decomposition temperature and an oxygen deficient atmosphere to form an enriched spent ore and carbon dioxide 120.

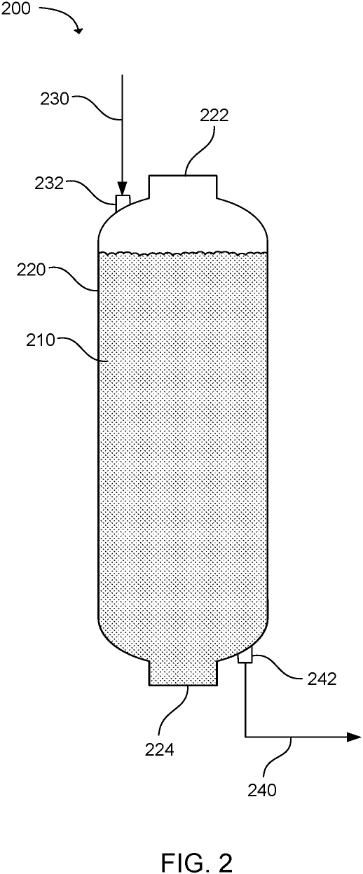

FIG. 2 is a schematic illustration of an example system 200 that can be used to perform a method of recovering rare earth elements and other trace metals from carbon-based ores. The system includes a body of rubblized carbon-based ore 210. The body of rubblized carbon-based ore is held inside a vessel 220. The rubblized carbon-based ore can be introduced into the vessel through an ore inlet 222. As mentioned above, the rubblized carbon-based ore can include carbonates and rare earth elements. The ore can be heated to an elevated decomposition temperature in the vessel to decompose the carbonates, forming an enriched spent ore. The enriched spent ore can be further processed inside the vessel or removed from the vessel through an ore outlet 224. The heating of the carbon-based ore can be accomplished using a heating fluid stream 230 that enters the vessel through a fluid inlet 232. An effluent fluid stream 240 flows out of the vessel through a fluid outlet 242. The effluent stream can include carbon dioxide that is formed from decomposing carbonates in the carbon-based ore. Other components of the effluent stream can include additional carbon dioxide formed from combustion inside the vessel, water vapor, and liquid and gaseous hydrocarbons.

The body of rubblized carbon-based ore can be contained inside a vessel such as the vessel shown in FIG. 2. The vessel can be a retort such as a vertical retort, a horizontal retort, an inclined retort, etc. The vessel can include walls formed of suitable materials such as steel, other metals, cement, ceramic, fire bricks, or others. In some examples, the vessel walls can be insulated or without insulation. The size and shape of the vessel is not particularly limited. In some examples, the vessel can be a vertical vessel having a height from about 10 meters to about 100 meters and a width from about 3 meters to about 30 meters. In certain examples, the height can be from about 30 meters to about 100 meters, or from about 50 meters to about 100 meters, or from about 10 meters to about 30 meters. In further examples, the width can be from about 10 meters to about 30 meters, or from about 20 meters to about 30 meters, or from about 3 meters to about 10 meters. If the vessel is an inclined vessel, the vessel can have similar dimensions to the vertical vessels described above, but turned on an incline. If the vessel is a horizontal vessel, the vessel can have similar dimensions to the vertical vessels described above, but turned horizontal.

Although the example shown in FIG. 2 includes a vessel to contain the body of carbon-based ore, in other examples the carbon-based ore may not be contained in an above-ground vessel. In certain examples, the methods described herein can be applied to an in-capsule system, similar to the systems described in U.S. Pat. No. 7,862,705, which is incorporated herein by reference. In these examples, the body of crushed carbon-based ore can be formed inside an earthen impoundment that prevents uncontrolled migration of gases and liquids into and out of the impoundment. The impoundment can include walls having multiple layers comprising particulate earthen materials such as swelling clay, gravel, spent carbon-based ore, and others. In some cases, the size of the impoundment can be relatively large. As an illustration, single impoundments can range in size from 15 meters across to 200 meters, and often from about 100 to 160 meters across. Optimal impoundment sizes may vary, but suitable impoundment areas can often range from about one-half to ten acres in top plan surface area. Additionally, the impoundment can have a depth from about 10 meters to about 50 meters.

In either case, as mentioned above, in some examples the body of carbon-based ore can be contained in a vessel having an ore inlet and an ore outlet. Carbon-based ore can be loaded through the ore inlet and then heated as a batch before removing the ore through the ore outlet. In such examples, the carbon-based ore can be substantially stationary during heating. In other examples, the process can be operated continuously and carbon-based ore can be continuously fed into the vessel at the ore inlet and removed from the vessel at the ore outlet. The carbon-based ore can be heated for a heating time from about 0.1 hour to about 24 hours, or from about 0.5 hour to about 20 hours, or from about 1 hour to about 12 hours, or from about 8 hours to about 24 hours. These times can be the time for heating a batch of ore in a batch process, or the residence time of more moving through the vessel in a continuous process.

Although some examples described herein focus on processing oil shale, the systems and methods described herein can also be used to process other types of carbon-based ore. The carbon-based ore can be a hydrocarbon-containing material from which hydrocarbon products can be extracted or derived. For example, hydrocarbons may be extracted directly as a liquid, removed via solvent extraction, directly vaporized, by conversion from a feedstock material, or otherwise removed from the material. Many carbon-based ores contain kerogen or bitumen which is converted to a flowable or recoverable hydrocarbon through heating and pyrolysis. Carbon-based ores can include, but are not limited to, oil shale, tar sands, coal, peat, tazmanite, and other organic rich rock. In certain examples, the carbon-based ore can be Green River oil shale from the Mahogany zone. Existing hydrocarbon-containing materials in the carbon-based ore can be upgraded and/or released from the carbon-based ore through a chemical conversion into more useful hydrocarbon products. Chemical conversion can include synthesis reactions, decomposition reactions or other reactions which result in chemically distinct product compounds. Such chemical conversions can be accomplished thermally, catalytically, and/or via addition of other chemical components.

Some carbon-based ores can also include carbonate minerals. Carbonates in the carbon-based ore can include calcite, dolomite, siderite, nahcolite, dawsonite, ankerite, barium carbonates (e.g. ewaldite and burbankite), and others. The amount of carbonate minerals in the carbon-based ore can vary depending on the type of carbon-based ore. In some examples, the carbon-based ore can include carbonate minerals in an amount of more than 0.5 wt%. In further examples, the carbon-based ore can include carbonate minerals in an amount from about 1 wt% to about 80 wt%. In a further example, the carbon-based ore can include volcanic tuffs (volcanic ash deposition layers) with high rare earth concentrations in specific carbonates, particularly barium carbonates ewaldite and burbankite. Some carbonate minerals can decompose thermally to form carbon dioxide when heated at a sufficient temperature. The decomposition temperature for some carbonate minerals can be from about 950° F. to about 1500° F. Other carbonate minerals can decompose at lower temperatures, such as from about 600° F. to about 950° F. The decomposition of carbonate minerals can increase the total amount of carbon dioxide obtained from the process. This also reduces the overall mass of the ore so that the concentration of rare earth elements in the ore is increased.

The carbon-based ore can also include rare earth elements and trace metals present in a combined concentration of at least 10 ppm by weight. This concentration can be present in the ore before performing the heating process described herein. In other examples, the initial combined concentration of rare earth elements and trace metals in the carbon-based ore can be at least 20 ppm, or at least 30 ppm, or at least 40 ppm, or at least 50 ppm. In some examples, the initial concentration can be from 10 ppm to 400 ppm, or from 10 ppm to 300 ppm, or from 10 ppm to 200 ppm, or from 10 ppm to 100 ppm. In still further examples, the concentration of rare earth elements alone can be within any of these ranges. The concentration of trace metals alone can also be within any of these ranges. The concentration of rare earth elements and trace metals can increase when the ore is heated to decompose carbonates. The ore is converted to an enriched spent ore by the heating process. The concentration of rare earth elements and trace metals in the enriched spent ore can be higher than the initial concentration in the carbon-based ore. However, in certain examples the trace metals can include metals that melt at a low temperature. These can be removed through a low-temperature heating process before the temperature is raised to decompose carbonates. Therefore, in some cases the concentration of trace metals can decrease if the trace metals are removed through a low-temperature heating process.

In various examples, the combined concentration of rare earth elements and trace metals in the enriched spent ore can be greater than 100 ppm, greater than 200 ppm, greater than 300 ppm, greater than 400 ppm, or greater than 500 ppm. In other examples, the combined concentration can be from 20 ppm to 2000 ppm, or from 30 ppm to 500, or from 50 ppm to 500 ppm, or from 20 ppm to 300 ppm, or from 20 ppm to 200 ppm. In still further examples, the concentration of rare earth elements alone can be within any of these ranges. The concentration of trace metals alone can also be within any of these ranges.

Examples of rare earth elements and other trace metals can include scandium, yttrium, lanthanum, cerium, praseodymium, neodymium, promethium, samarium, europium, gadolinium, terbium, dysprosium, holmium, erbium, thulium, ytterbium, germanium, gallium, uranium, and lutetium. In a particular example, the enriched spent ore and/or the carbon-based ore can include at least one of gallium and germanium in a concentration greater than 15 ppm. In still another specific example, the enriched spent ore can comprise at least one of lanthanum, cerium, yttrium, and neodymium at an individual concentration of greater than 1200 ppm, and in some cases greater than 2000 ppm.

If the carbon-based ore contains gallium metal, the method can include a low-temperature melt stage prior to the step of decomposing carbonates in the carbon-based ore. Gallium has a melting point of about 86° F., which is much lower than the decomposition temperature of most carbonate minerals. In the low-temperature melt stage, the carbon-based ore can be heated to a low melt temperature that is sufficient to melt gallium metal but insufficient to cause decomposition of the carbonates. In certain examples, the low melt temperature can be from about 84° F. to about 200° F. In further examples, the low melt temperature can be from about 100° F. to about 200° F. or from about 100° F. to about 150° F. or from about 150° F. to about 20° F. Molten gallium can be collected through a liquid outlet in the vessel containing the rubblized carbon-based ore in some examples.

In some examples, the body of rubblized carbon-based ore used in the methods described herein can be a body of raw carbon-based ore. As used herein, “raw carbon-based ore” refers to carbon-based ore that has not been processed to remove any hydrocarbon content from the ore. For example, oil shale that has not undergone a pyrolysis process to convert kerogen in the oil shale to hydrocarbon products would be a raw carbon-based ore.

As mentioned above, hydrocarbons can be removed from carbon-based ore, thereby increasing the concentration of rare earth elements in the remaining enriched spent ore. In certain examples, hydrocarbons can be removed by a pyrolysis process that occurs simultaneously with decomposing the carbonate minerals in the ore. Raw carbon-based ore can be heated under an oxygen deficient atmosphere to produce water, carbon dioxide, enriched spent ore, and hydrocarbon products through pyrolysis of hydrocarbon contents in the carbon-based ore. Combustion of hydrocarbons or other organic content can produce carbon dioxide and water vapor. Additional carbon dioxide can be produced by the decomposition of carbonate minerals. If no oxygen is present in the atmosphere, then substantially all the carbon dioxide can be produced by decomposing carbonate minerals. However, in examples that involve combustion within the body of rubblized carbon-based ore, a limited amount of oxygen can be introduced into the body of rubblized carbon-based ore so that combustion occurs within the body of rubblized carbon-based ore. The heat generated by the combustion reaction can drive the decomposition of carbonate minerals and also the pyrolysis of organic contents in the ore. The concentration of oxygen in the body of rubblized carbon-based ore can be kept at below stoichiometric levels, meaning that the amount of oxygen present is not sufficient to burn all of the hydrocarbons and other combustible organic content present. By using a sub-stoichiometric amount of oxygen, the temperature of the body of rubblized carbon-based ore can be controlled and kept at a relatively low temperature. In some examples, the rubblized carbon-based ore can be heated to an elevated temperature from 600° F. to 950° F. This elevated temperature can be lower than the temperature that would be reached if a stoichiometric amount of oxygen were used. In further examples, raw carbon-based ore can be heated at an elevated temperature from 600° F. to 900° F., or 600° F. to 800° F., or 600° F. to 700° F., or 700° F. to 950° F., or 800° F. to 950° F.

In other examples, the rubblized carbon-based ore used in the methods described herein may include spent carbon-based ore. As used herein, “spent carbon-based ore” and “spent oil shale” refer to materials that have already been used to produce hydrocarbons. Typically, after producing hydrocarbons from a carbon-based ore, the remaining material is mostly mineral with the organic content largely or completely removed. In some cases, spent oil shale can have a sufficient amount of residual hydrocarbon or carbon content that the spent oil shale can be burned to generate additional heat. Additionally, the spent carbon-based ore can include carbonate minerals that can decompose when heated at an elevated decomposition temperature as described above.

In certain examples, spent carbon-based ore can be obtained through a low-temperature pyrolysis process such as the oxygen-limited pyrolysis process described above. However, a low-temperature pyrolysis process that is performed in an oxygen-free atmosphere can also be used. The temperature of the pyrolysis process can be from 600° F. to 950° F., or 600° F. to 900° F., or 600° F. to 800° F., or 600° F. to 700° F., or 700° F. to 950° F., or 800° F. to 950° F., in some examples. This pyrolysis process can produce hydrocarbon products and the spent carbon-based ore from which the hydrocarbon products have been removed. This spent ore can then be heated to an elevated decomposition temperature to decompose carbonates in the spent ore. Some carbonate minerals can have a higher decomposition temperature than the pyrolysis temperature that was used during the low-temperature pyrolysis process. Therefore, the spent ore can be heated to a higher temperature after the hydrocarbon products have been removed by pyrolysis. In certain examples, the spent ore can be heated to a decomposition temperature from 950° F. to 1500° F. to decompose carbonate minerals in the spent ore. In further examples, the spent ore can be heated to a temperature from 1000° F. to 1500° F., or from 1100° F. to 1500° F., or from 1200° F. to 1500° F., or from 1300° F. to 1500° F., or from 1400° F. to 1500° F., or from 1000° F. to 1100° F., or from 1000° F. to 1200° F., or from 1000° F. to 1300° F., or from 1000° F. to 1400° F.

In some examples, the body of rubblized carbon-based ore can be formed from particulate carbon-based ore that is sized to obtain a desired target void space. The body of carbon-based ore can have greater than about 10% void space, or can have void space from about 20% to 50%, although other ranges may be suitable such as up to about 70%. High void space can allow for high permeability of the body of carbon-based ore. Allowing for high permeability facilitates heating of the body through convection as the primary heat transfer mechanism while also substantially reducing costs associated with crushing to very small sizes, e.g. below about 2.5 to about 1 cm. Specific target void space can vary depending on the particular carbon-based ore and desired process times or conditions. Particle sizes throughout the body of carbon-based ore can vary depending on the material type, desired heating rates, and other factors. In some examples, the body of rubblized carbon-based ore can include particles up to about 2 meters in size, or less than 30 cm, or less than about 16 cm. In certain examples, the maximum particle size of the carbon-based ore can range from about 5 cm to about 60 cm, or about 16 cm to about 60 cm, or from about 1 cm to about 5 cm. In further examples, the average particle size of the rubblized carbon-based ore can be from about 1 mm to about 60 cm, or from about 5 mm to about 30 cm, or from about 5 mm to about 10 cm, or from about 5 mm to about 5 cm. Optionally, the body of rubblized carbon-based ore can include bi-modal or multi-modal size distributions in order to provide increased balance of void space and exposed particulate surface area. The void space and exposed particulate surface can be useful for allowing heating fluid to pass through the ore and contact ore particles and also for removing materials from the ore particles such as hydrocarbon products and carbon dioxide produced by decomposing carbonate minerals in the ore.

The rubblized carbon-based ore being heated can maintain a sufficient porosity (e.g. bed void space) to allow gas transport through the body of rubblized carbon-based ore throughout the heating process. In particular, the rubblized carbon-based ore can maintain a sufficient porosity to allow gas transport of the gaseous and vapor hydrocarbon products that are produced during pyrolysis, and carbon dioxide gas that is produced during heating. Some types of carbon-based ore can have inherent porosity. Mineral materials such as oil shale can include a rigid mineral structure that has porosity including pores that are internal in individual particles of the material, or void spaces between rigid particles of the material, or a combination thereof. Other types of carbon-based ore may not have inherent porosity. In certain examples, the carbon-based ore can be mixed with a rigid mineral material such as oil shale. The mineral structure of the oil shale can survive the pyrolysis process and the mineral structure can maintain the porosity of the body of carbon-based ore. Any other carbon ore materials that may not have sufficient porosity can likewise be mixed with a secondary carbon ore material that has a mineral structure that can survive the pyrolysis process. Thus, the combined body of carbon ore can maintain sufficient porosity to allow gas transport of gas and vapor hydrocarbon products during pyrolysis. Thus, although porosity can vary considerably, a porosity of 15% to about 65%, and in some cases 30% to 50% can be used.

Raw oil shale can be obtained and rubblized to a desired particle distribution and size. Kerogen content in raw oil shale can vary depending on the particular formation source from which it is mined. Similarly, mineral content and other composition variables can vary considerably among different raw oil shales. However, as a very general guideline, the initial kerogen content is greater than 5% by weight. In some cases, the initial kerogen content can be greater than 50% such as when treating raw oil shale. Alternatively, the methods described herein can be applied to carbon-based ore having a lower initial kerogen content such as from 5% to 50% by weight, and in some cases 5% to about 35% by weight.

As mentioned above, the body of rubblized carbon-based ore can be heated under an oxygen deficient atmosphere. A working fluid can be passed through the body of rubblized carbon-based ore to facilitate heating of the ore. In some examples, the working fluid can include oxygen in a sub-stoichiometric amount and the oxygen can support combustion within the body of rubblized carbon-based ore. The combustion can provide at least some of the heat for heating the ore in such examples. In certain examples, the working fluid can be introduced at a low temperature such as around room temperature or ambient temperature, and then combustion within the body of rubblized carbon-based ore can provide a sufficient amount of heat to heat the ore up to the elevated decomposition temperature of the carbonate minerals in the ore. The working fluid can also be preheated before the working fluid is injected into the body of rubblized carbon-based ore. Some heat can be contributed by this preheating and the remaining heat can be produced by combustion within the body of rubblized carbon-based ore. In alternative examples, the working fluid can be free of oxygen and all of the heat used to heat the ore can be introduced by preheating the working fluid.

The working fluid can include hydrocarbon gases, hydrocarbon vapors, steam, hot air, oxygen, and other fluids in a variety of mixtures or ratios. In some examples, the oxygen concentration in the working fluid can be less than about 21% by volume. In other examples, the oxygen concentration can be less than 10% by volume, or less than 5% by volume. In certain examples, the working fluid can consist essentially of hydrocarbon gas and oxygen in one of these concentrations. The oxygen can be in the form of air, oxygen-enriched air, pure oxygen, or another mixture including oxygen. In certain examples, pure oxygen can be provided from an oxygen tank. In other examples, pure oxygen, nearly pure oxygen, or oxygen-enriched air can be provided by a pressure swing oxygen generator or oxygen concentrator.

The working fluid can be injected into the body of rubblized carbon-based ore as a single fluid stream or as multiple fluid streams that mix together after injection. For example, the rubblized carbon-based ore can be contained in a vessel and the working fluid can be injected into the vessel. In a certain example, a working fluid that includes hydrocarbon gas and oxygen can be injected into the vessel as a single gas stream. However, in an alternative example, oxygen can be injected in a separate stream from the hydrocarbon gas. Injecting oxygen as a separate stream can be useful because the concentration of oxygen in the vessel can be adjusted by changing the flow rate of the oxygen stream into the vessel. The concentration of oxygen can be related to the temperature in the vessel, since a higher oxygen concentration can support combustion at a higher temperature in the vessel. Thus, a process control system can be used to control the temperature in the vessel by adjusting the flow rate of oxygen into the vessel. In certain examples, an oxygen stream and a hydrocarbon stream can be injected into a headspace in the vessel above the rubblized carbon-based ore. The oxygen and hydrocarbon gas can mix in the headspace and within the rubblized carbon-based ore as the gases pass through the vessel. The oxygen stream can be pure oxygen in some examples, while in other examples the oxygen stream can include oxygen mixed with an inert gas such as nitrogen, argon, or other gas. The oxygen stream may also be a mixture of oxygen and a hydrocarbon gas, and a secondary hydrocarbon stream can also be injected. This can allow the concentration of oxygen to be adjusted by adjusting the flow rates of the oxygen stream and/or the secondary hydrocarbon stream. In certain examples, the hydrocarbon stream or secondary hydrocarbon stream can be a recycle stream that recycles hydrocarbons collected from the body of rubblized carbon-based ore.

In other examples, the concentration of oxygen in the working fluid can be varied by pre-mixing a desired amount of oxygen with other components of the working fluid and then injecting the mixture into the body of rubblized carbon-based ore. For example, oxygen can be premixed with a hydrocarbon gas stream. The amount of oxygen added to the hydrocarbon gas stream can be selected to provide a specific oxygen concentration. The mixture of oxygen and hydrocarbon gas can then be injected into the body of rubblized carbon-based ore or vessel containing the ore. This can allow the oxygen concentration of the working fluid stream to be controlled. In some examples, the hydrocarbon stream can be a recycle stream as mentioned above.

When the working fluid includes oxygen, the working fluid can be injected at a temperature that is less than an autoignition temperature of the working fluid. In some examples, a combustion region or combustion front can be present at a location in the body of rubblized carbon base ore. The ore in this region can be at or above the autoignition temperature of the working fluid. When the working fluid contacts this region, the working fluid can ignite, causing a combustion reaction of the oxygen and hydrocarbons. It is noted that the working fluid can include hydrocarbons in some examples, while in other examples the working fluid may not include hydrocarbons but the carbon-based ore can contain hydrocarbons or other combustible material that can participate in the combustion reaction with oxygen. Thus, the oxygen in the working fluid can support the combustion within the body of rubblized carbon-based ore and the combustion can provide heat to continue heating the carbon-based ore. In further examples, igniters can be used to ignite the working fluid. For example, the working fluid can be injected into the vessel at a temperature below the autoignition temperature of the working fluid, and then igniters located inside the vessel can be used to ignite the working fluid to initiate the combustion reaction.

Although the working fluid can include a variety of different gases in combination, in some examples it can be useful to minimize the number of components in the working fluid. This can be useful to make it easier to separate components of the effluent stream that flows out of the body of rubblized carbon-based ore. In some examples, the working fluid can consist or consist essentially of oxygen and hydrocarbon gas. The hydrocarbon gas can include one or multiple light hydrocarbons, such as methane, ethane, and propane. In certain examples, oxygen and hydrocarbon gas can make up at least 95% by volume of the working fluid, or at least 98% by volume, or at least 99% by volume of the working fluid. The oxygen can be substantially all consumed by combustion reactions within the body of rubblized carbon-based ore. Therefore, the effluent stream from the body of rubblized carbon-based ore can include little or no oxygen. The effluent stream can be primarily made up of or consist essentially of carbon dioxide, water vapor, and hydrocarbons. The hydrocarbons can include hydrocarbon gas that was injected as working fluid, which remains uncombusted, and/or hydrocarbons that were derived from heating the carbon-based ore. In some examples, the effluent stream can be at least 95% by volume, or at least 98% by volume, or at least 99% by volume made up of carbon dioxide, water vapor, and hydrocarbons. The carbon dioxide, hydrocarbons, and water can then be separated one from another.

In certain examples, the working fluid can be free of nitrogen gas or substantially free of nitrogen gas, so that the effluent can also be free or substantially free of nitrogen gas. This can be useful because using a nitrogen-free atmosphere eliminates the need for separating nitrogen from the other components of the effluent, or alternatively venting a portion of the effluent to get rid of parasitic nitrogen. As mentioned above, the method can include recycling hydrocarbon gases separated from the effluent back to the body of rubblized carbon-based ore. The hydrocarbon gas can be used as a fuel for combustion and as a heat carrier fluid. However, if nitrogen is introduced in the working fluid, such as by using air to supply oxygen, then nitrogen would accumulate in the recycle stream unless excess nitrogen is vented to the atmosphere. Such venting would waste heat energy that could otherwise be used in the heating process. Additionally, if the recycle stream includes both nitrogen and hydrocarbons then some hydrocarbons would be vented to the atmosphere as well. The hydrocarbons could otherwise be used as fuel in the heating process.

In some examples, the working fluid can be injected into the vessel at a temperature from 0° F. to 600° F., or from 100° F. to 600° F., or from 200° F. to 600° F., or from 300° F. to 500° F., or from 100° F. to 300° F. If multiple different streams are injected into the vessel, then the average temperature of these streams when mixed together can be within these ranges. As mentioned above, the working fluid can include oxygen and hydrocarbon gas, and the initial temperature of the working fluid can be below the autoignition temperature of the working fluid. In further examples, the working fluid can be free of oxygen and the injection temperature can be from 600° F. to 950° F., or from 600° F. to 900° F., or from 600° F. to 800° F., or from 600° F. to 700° F., or from 700° F. to 950° F., or from 800° F. to 950° F. In still further examples, the working fluid can be free of oxygen and the injection temperature can be from 1000° F. to 1500° F., or from 1100° F. to 1500° F., or from 1200° F. to 1500° F., or from 1300° F. to 1500° F., or from 1400° F. to 1500° F., or from 1000° F. to 1100° F., or from 1000° F. to 1200° F., or from 1000° F. to 1300° F., or from 1000° F. to 1400° F.

The flow rate of working fluid into the body of rubblized carbon-based ore can vary depending on the volume of the body of carbon-based ore. In some examples, the flow rate of working fluid into the body of rubblized carbon-based ore can be sufficient to replace the volume of gas in the body of rubblized carbon-based ore from about once per minute to about once per day. The volume of gas in the body can correspond to the void space volume in the body of rubblized carbon-based ore. In further examples, the flow rate of working fluid can be sufficient to replace the volume of gas in the body of rubblized carbon-based ore from about once per ten minutes to about once per day, or from about once per hour to about once per day, or from about once per minute to about once per hour.

During processing, temperature profiles throughout the body of rubblized carbon-based ore can provide valuable feedback for controlling operation of the process. Accordingly, in one example, the method can include actively monitoring an outlet temperature and/or a combustion temperature in order to dynamically adjust at least one of the inlet mass flow rate, the inlet temperature, and the inlet oxygen concentration. As a specific example, the actively monitoring can include use of at least one temperature sensor associated with an internal surface of the vessel or the rubblized carbon-based ore bed.

Although pressures can vary somewhat, most often the body of rubblized carbon-based ore can be maintained at a pressure from about 0.8 atm to about 2 atm during the heating process.

Some carbon-based ores can release liquid hydrocarbons when heated. These liquid hydrocarbons can drain through the bed of carbon-based ore to the bottom of the vessel. In some examples, a liquid outlet can be located at or near the bottom of the vessel. In certain examples, the liquid outlet and the effluent outlet can be a single outlet. In other examples, an effluent outlet can be used to remove gas and vapor components, such as the carbon dioxide, water vapor, and non-condensed hydrocarbons liberated from the oil shale. A liquid outlet that is separate from the effluent outlet can be used to remove liquid hydrocarbon products from the vessel.

In certain examples, the carbon dioxide produced in the body of rubblized carbon-based ore can be separated from other components of the effluent stream using one or more suitable separators. The effluent stream can also include water vapor and condensable hydrocarbons in addition to the carbon dioxide. As a first stage of separation, the water and condensable hydrocarbons can be condensed to form liquid water and liquid hydrocarbons. These can be easily separated from the gaseous components of the effluent stream. The carbon dioxide can then be separated from the non-condensable hydrocarbons. The non-condensable hydrocarbons can then be recycled as a heat carrier gas and fuel gas for use in heating the body of rubblized carbon-based ore.

Some examples of separators that can be used to separate carbon dioxide from non-condensed hydrocarbons can include cryogenic distillation separators, membrane separators, sorbent separators, and solvent separators. Solvent separators can employ solvents to scrub carbon dioxide from the hydrocarbon gas of the effluent stream. The carbon dioxide can subsequently be separated from the solvent to regenerate the solvent. In some examples, solvents can include amine compounds such as monoethanolamine. Sorbent separators can include a solid sorbent material such as a zeolite or activated carbon. Some sorbent separators use pressure swing adsorption or temperature swing adsorption. Membrane separators include a gas separation membrane that can allow some gases to pass through faster than others. Some membrane materials include porous inorganic membranes, palladium membranes, polymeric membranes, and zeolites. Cryogenic separation involves cooling the effluent stream condense some components of the stream. Carbon dioxide can be condensed at a sufficiently high pressure and low temperature.

In some examples, carbon dioxide produced from the body of carbon-based ore can be reused as a solvent. In particular, supercritical carbon dioxide can be an effective solvent that can remove certain materials from carbon-based ore. The carbon dioxide can be used to remove additional materials from the same body of carbon-based ore from which the carbon dioxide was produced, or alternatively the carbon dioxide can be injected into a second body of carbon-based ore to remove materials from the second body of carbon-based ore. For example, some types of carbon-based ore can contain bitumen. The bitumen can be extracted by injecting supercritical carbon dioxide into the ore. Therefore, in certain examples the carbon dioxide produced by the methods described herein can be injected as supercritical carbon dioxide into such a carbon-based ore to remove bitumen. For example, supercritical carbon dioxide can be injected into a vessel containing the ore. After flowing supercritical carbon dioxide through the vessel for a sufficient time to remove the bitumen, the pressure in the vessel can be reduced so that the supercritical carbon dioxide is converted to a gas and leaves the ore. In some cases, this can leave behind a porous residual ore, where the ore includes empty pores that had originally been filled with bitumen. Removing the bitumen can increase the overall concentration of rare earth elements and other trace metals in the ore. Removing the bitumen can also expose these elements which may have originally been covered by the bitumen. This can make it easier to access and remove the rare earth elements and other trace metals.

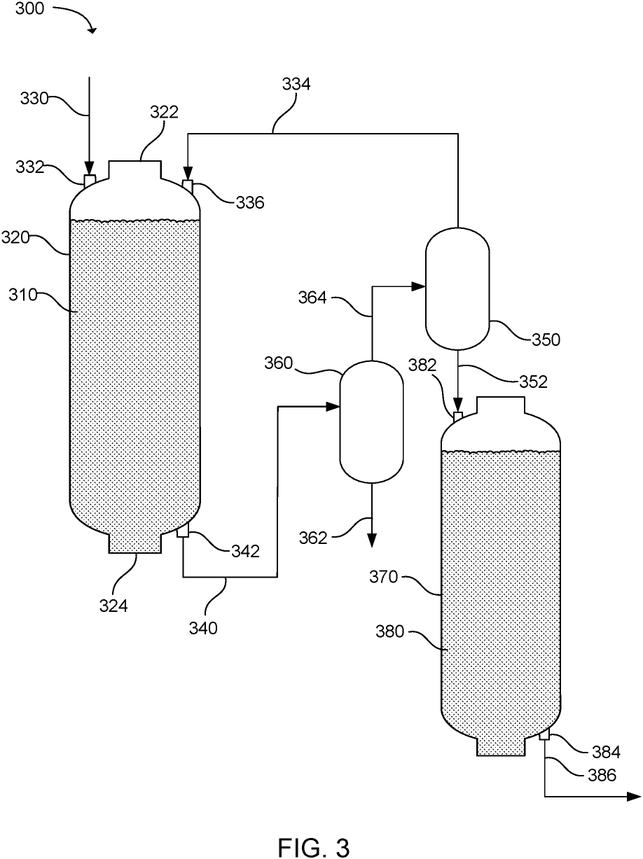

FIG. 3 shows an example system 300 that can be used to heat carbon-based ore to a decomposition temperature to decompose carbonates in the ore. The carbon dioxide formed from this process is then used as a solvent to remove bitumen. This system includes a first body of rubblized carbon-based ore 310 inside a first vessel 320. The first vessel includes an ore inlet 322 and an ore outlet 324. A working fluid stream 330 flows into the first vessel through a working fluid inlet 332. As explained above, the working fluid can include a less than stoichiometric amount of oxygen. The rubblized carbon-based ore in the first vessel can be heated by heat transferred from the working fluid and/or heat generated by combustion within the first body of rubblized carbon-based ore. The effluent stream 340 from the first vessel can include carbon dioxide, water vapor, and optionally hydrocarbons. The effluent stream flows out of the first vessel through a fluid outlet 342. The effluent stream flows to a gas/liquid separator 360 that separates liquid hydrocarbons and water from gaseous components of the effluent stream. The liquids flow out as liquid stream 362 and the gaseous components flow out as gas stream 364. The gas stream flows to a second separator 350 that separates the carbon dioxide from hydrocarbon gas in the gas stream. A carbon dioxide stream 352 and a recycle stream 334 flow out of the separator. The recycle stream, which includes the hydrocarbon gases, is recycled back to the first vessel via inlet 336. The carbon dioxide stream flows into a second vessel 370 through a carbon dioxide inlet 382. The second vessel contains a second body of rubblized carbon-based ore 380. This ore contains hydrocarbons that can be removed by carbon dioxide acting as a solvent. In some cases, the carbon dioxide can be compressed to a supercritical state before being injected into the second vessel. A mixture of carbon dioxide and hydrocarbons can flow out a product outlet 384 as a product stream 386. In certain examples, the ore in the second body of rubblized carbon-based ore can be ore that has already undergone a heating process to produce hydrocarbons therefrom, and the carbon dioxide can be injected to recover additional hydrocarbons. In other examples, the ore in the second body of rubblized carbon-based ore can be subjected to a heating process after the carbon dioxide has been injected to remove the hydrocarbons. The heating process, whether performed before or after injecting supercritical carbon dioxide as a solvent, can decompose carbonates in the ore and optionally remove hydrocarbons from the ore so that the concentration of rare earth elements and other trace metals increases.

After the step of heating the carbon-based ore to decompose carbonates has been completed, forming an enriched spent ore, the rare earth elements and other trace metals can be recovered from the enriched spent ore. The recovery of the rare earth elements and other trace metals can also be after any other steps of removing other materials from the ore, such as pyrolysis steps for removing hydrocarbons, low temperature melting steps for removing gallium or other low melting materials, removal of bitumen using supercritical carbon dioxide, and any other steps of removing materials from the ore. The rare earth elements and other trace metals can be recovered from the enriched spent ore using a suitable separation process.

Leaching can be used to recover rare earth elements and trace metals from the enriched spent ore by percolating a leaching agent through the enriched spent ore. In some cases, the enriched spent ore can be subjected to a leaching step while the ore is still in the same vessel where the heating was performed. A leaching agent can be introduced into the vessel, for example through an inlet at the top of the vessel. The leaching agent can remove rare earth elements or other trace metals from the enriched spent ore as the leaching agent percolates through the body of enriched spent ore. The leaching agent can then be collected from a liquid outlet. In various examples, leaching agents can include chelating agents such as diglycolamides, N,N-dicarboxymethyl glutamic acid, methylglycinediacetic acid, oxalic acid, citric acid, iminodiacetate, other acids such as hydrochloric acid, sulfuric acid, phosphoric acid, nitric acid, and other lixiviants such as ammonium chloride, ammonium sulfate, sodium cyanide, sodium chloride, calcium sulfate, magnesium sulfate. Some of these agents can also be used as solvent extraction agents or ion exchange agents. Solvent extraction and ion exchange steps can refer to either a step of removing rare earth elements and trace metals directly from the enriched spent ore or a subsequent step of extracting dissolved rare earth elements and trace metals that have already been dissolved in a leaching agent.

The enriched spent ore produced by the methods described herein can be porous in some cases. Removing carbonate minerals and other materials such as kerogen and bitumen can leave empty pores. The increased porosity of the ore after heating can be beneficial for the leaching processes described above because the porosity can increase the contact between leaching agents and rare earth elements and other trace metals in the enriched spent ore. However, in some cases it can be useful to further pulverize the enriched spent ore before recovering the rare earth elements and other trace metals. Therefore, the methods described herein can include a step of pulverizing the enriched spent ore in some examples. The enriched spent ore can be pulverized to an average particle size from about 1 micrometer to about 1 centimeter, or from about 10 micrometers to about 1 cm, or from about 100 micrometers to about 1 centimeter, or from about 1 micrometer to about 1 millimeter, or from about 10 micrometers to about 1 millimeter, or from about 100 micrometers to about 1 millimeter. Pulverization can be performed using a suitable pulverizing process, such as bowl milling, ball milling, roller milling, tube milling, hammer milling, and others. Pulverizing the enriched spent ore can be useful before a leaching step, or before other types of separation steps such as magnetic separation, electrostatic separation, flotation, density-based separation, and others.

Magnetic separation can be used to remove magnetic metals from the enriched spent ore in some examples. This can further increase the concentration of rare earth elements and other trace metals in the enriched spent ore. Magnetic separation can be performed using a magnetic separator that includes permanent magnets or electromagnetics to attract iron-containing materials unit of the ore. Electrostatic separation can also be used in the methods described herein. Electrostatic separation can involve using differences in conductivity of particles of ore in order to separate the more conductive particles from the less conductive particles.

Density based separation is another way that various materials in the enriched spent ore can be separated. One form of density-based separation involves mixing the enriched spent ore with a dense liquid. The density of the liquid can be selected so that some denser components of the enriched spent ore will sink in the liquid, while some less-dense components can float. Other density-based separation processes can include fluidizing particles of enriched spent ore in a fluidized bed with a fluidizing gas. Less dense particles can be entrained in the gas more than denser particles, and thus the less dense particles can be separated from the denser particles. Another density-based separation that can be employed involves air tables, and can be deployed in coal mines around the world. This technology can be used in enriching oil shale ores, and can also be deployed to enrich rare earth rich areas of the deposits, since the rare earth bearing barium carbonates are often approximately two times as dense as other contained minerals.

Flotation can also be used to separate materials in the enriched spent ore. The enriched spent ore can be pulverized as described above to form small grains of different minerals contained in the enriched spent ore. The pulverized ore can then be mixed with water and the minerals to be separated can be selectively rendered hydrophobic. The minerals to be separated can be rendered hydrophobic by adding a surfactant such as sodium dodecyl sulfate, rhamnolipids, alkyl hydroxamates, sodium oleate, phosphoric acid esters, or others. A stream of air bubbles can then be passed through the water. The air bubbles can preferentially attach to the hydrophobic particles and cause the hydrophobic particles to float on the water. Particles that are more hydrophilic will sink to the bottom of the water. The effectiveness of the separation can depend on the particular materials present, the type of surfactant used, the pH of the mixture, amount of air added, time allowed for flotation, and other factors. Depending on the type of mineral to be floated and the other materials present, a combination of surfactant, pH, air bubbling, and flotation time can be determined that is effective for separating the target minerals. In some examples the rare earth elements or other trace metals can be targeted for flotation, or in other examples some other material can be targeted for flotation and the rare earth elements or other trace metals can remain in the hydrophilic material that sinks in the water.

In various examples, any of the separation processes described herein can be performed in the same vessel where the carbon-based ore was heated, or in a separate vessel. In certain examples, a method can include heating carbon-based ore in a first vessel to decompose carbonate minerals and form enriched spent ore, and then removing the enriched spent ore from the first vessel and performing one or more separation processes on the enriched spent ore after it has been removed from the first vessel. In a particular example, the enriched spent ore can be removed from the first vessel and then pulverized to a smaller particles size. The pulverized ore can then be transferred to a second vessel and another separation stage can be performed. In further examples, multiple separation stages can be performed.

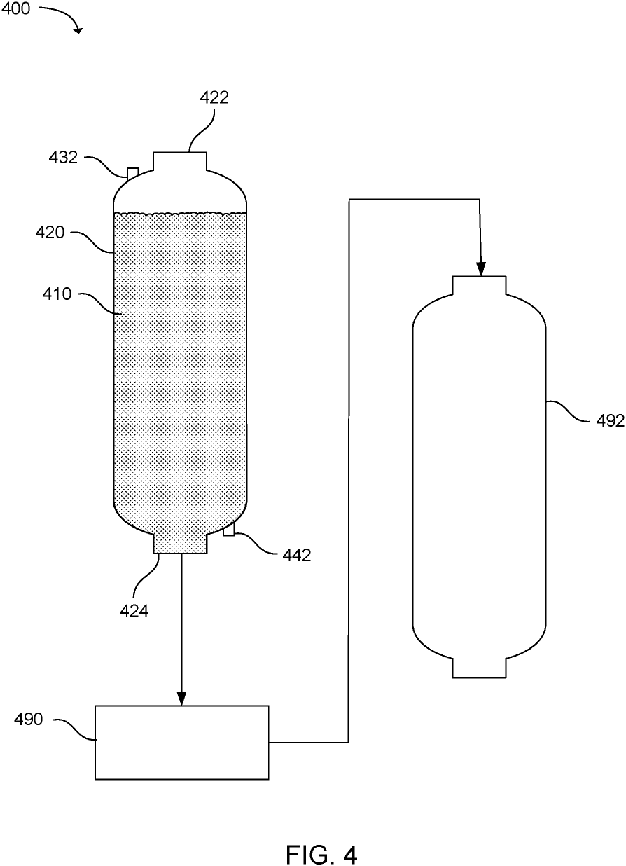

FIG. 4 shows another example system 400 that can be used in a method of recovering rare earth elements or other trace metals from carbon-based ore. This system includes a body of rubblized carbon-based ore 410 inside a first vessel 420. As in previous examples, the first vessel includes an ore inlet 422 and an ore outlet 424. The carbon-based ore can be heated in the first vessel to decompose carbonate minerals and remove hydrocarbons and other materials as described above. The first vessel includes a working fluid inlet 432 for working fluid to flow into the first vessel, and an effluent outlet 442 for effluent fluid to flow out of the first vessel. Although not shown in this figure, the system can also include a working fluid line and an effluent line as in the examples described above. The heating step can convert the carbon-based ore to a rare earth enriched spent ore. After the heating step is complete, the rare earth enriched spent ore can be removed from the first vessel through the ore outlet and then loaded into a pulverizer 490. The enriched spent ore can be pulverized to a smaller particle size. The pulverized ore can then be loaded into a separation vessel 492. A separation process can be performed, such as any of the separation processes described above or other separation processes to recover rare earth elements or other trace metals from the ore. In certain examples, a separation step can be performed in the separation vessel with one body of pulverized ore while a heating step is performed in the first vessel with another body of carbon-based ore simultaneously. In further examples, a pulverization step can also be performed simultaneously in the pulverizer on an additional body of enriched spent ore.

The recovered rare earth element product can be further purified through one or more of calciothermic purification, electrolytic purification, and lanthanothermic purification.

It is noted that the examples shown in the figures include vessels that are oriented vertically. However, the methods described herein can be performed with vessels having any orientation, such as vertical, horizontal, or inclined. Additionally, the direction of flow of gases through the vessels is depicted as being in a top-down direction in the examples shown in figures. However, the methods described herein can also be performed with a different direction of flow. In some examples, gases can flow from the bottoms of the vessels toward the tops of the vessels. In other examples, gases can flow from one side to another, such as in horizontal vessels. If inclined vessels are used, gases can flow from an upper end of the vessel to a lower end or from a lower end to an upper end. Liquids can flow in a downward direction under the force of gravity. Therefore, it can be useful to have a liquid outlet at or near a bottom of the vessels. In certain examples, it can also be useful to have the direction of gas flow in a top-down direction because this can result in cooler regions of the carbon ore being lower in the vessel, and condensed liquids can flow downward under the force of gravity through the cooler regions without being re-vaporized.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A method of recovering rare earth elements and other trace metals from carbon-based ores, comprising:
a) providing a body of rubblized carbon-based ore which includes carbonates and rare earth elements; and
b) decomposing the carbonates at an elevated decomposition temperature and an oxygen deficient atmosphere to form an enriched spent ore and carbon dioxide.

2. The method of claim 1, wherein the rubblized carbon-based ore is a raw carbon-based ore.

3. The method of claim 2, wherein the decomposing is performed simultaneously with a low temperature pyrolysis process in which the carbon-based ore is pyrolyzed via an oxygen limited pyrolysis process to produce a hydrocarbon product and the enriched spent ore.

4. The method of claim 3, wherein the elevated decomposition temperature is from 600° F. to 950° F.

5. The method of claim 1, wherein the rubblized carbon-based ore is a spent ore obtained through a low temperature pyrolysis process in which the carbon-based ore is pyrolyzed via an oxygen limited pyrolysis process to produce a hydrocarbon product and the spent ore.

6. The method of claim 5, wherein the decomposing is performed on the spent ore.

7. The method of claim 6, wherein the elevated decomposition temperature is from 950° F. to 1500° F.

8. The method of claim 1, wherein the carbon-based ore comprises at least one of oil shale, coal, tar sands, peat, and tazmanite.

9. The method of claim 1, wherein the carbon-based ore is coal.

10. The method of claim 1, wherein the carbon-based ore comprises Green River oil shale from the Mahogany zone.

11. The method of claim 1, wherein the rare earth elements and trace metals are present in the rubblized carbon-based ore at a concentration of at least 10 ppm.

12. The method of claim 1, wherein the carbonates are present at more than 0.5% by weight of the rubblized carbon-based ore.

13. The method of claim 1, wherein the enriched spent ore has rare earth element and other trace metal concentration of greater than 500 ppm.

14. The method of claim 1, wherein the enriched spent ore comprises at least one of scandium, yttrium, lanthanum, cerium, praseodymium, neodymium, promethium, samarium, europium, gadolinium, terbium, dysprosium, holmium, erbium, thulium, ytterbium, germanium, gallium, uranium, and lutetium.

15. The method of claim 1, wherein the enriched spent ore further comprises at least one of gallium and germanium in a concentration greater than 15 ppm.

16. The method of claim 1, wherein the enriched spent ore comprises at least one of lanthanum, cerium, yttrium, and neodymium at an individual concentration of greater than 1200 ppm.

17. The method of claim 1, wherein the enriched spent ore comprises at least one of lanthanum, cerium, yttrium, and neodymium at an individual concentration of greater than 2000 ppm.

18. The method of claim 1, wherein the oxygen deficient atmosphere includes oxygen at less than 10% by volume.

19. The method of claim 1, wherein the elevated decomposition temperature is below a stoichiometric combustion temperature and is controlled by maintaining oxygen concentrations below stoichiometric ratios.

20. The method of claim 19, wherein the oxygen concentrations are maintained by varying at least one of inlet oxygen concentrations and inlet oxygen mass flow rates.

21. The method of claim 1, further comprising exposing the body of rubblized carbon-based ore to a low temperature melt stage prior to the step of decomposing, wherein the low temperature melt stage includes heating to a low melt temperature which is sufficient to melt gallium and insufficient to cause decomposition of the carbonates.

22. The method of claim 21, wherein the low melt temperature is from about 84° F. to 200° F.

23. The method of claim 1, further comprising recovering the rare earth elements as a rare earth element product by one or more of leaching, pulverization and magnetic/electrostatic separation, flotation, solvent extraction, ion exchange, and density-based separation.

24. The method of claim 23, further comprising purifying the rare earth element product through one or more of calciothermic purification, electrolytic purification, and lanthanothermic purification.

25. The method of claim 1, wherein the body of rubblized carbon-based ore is provided in a vessel.

26. The method of claim 1, wherein the body of rubblized carbon-based ore is provided in an earthen impoundment.
